(19) United States
(12) Patent Application Publication
(10) Pub. No.: US 2015/0237829 A1
(43) Pub. Date: Aug. 27, 2015

(54) Fetch and Retrieve Tossing Toy

(71) Applicant: OurPet's Company, Fairport Harbor, OH (US)

(72) Inventor: Steven Tsengas, Fairport Harbor, OH (US)

(21) Appl. No.: 14/664,815

(22) Filed: Mar. 21, 2015

Related U.S. Application Data
(63) Continuation-in-part of application No. 13/756,171, filed on Jan. 31, 2013.

(51) Int. Cl. A01K 11/00

(52) U.S. Cl. CPC A01K 15/026

(57) ABSTRACT

A pet toy is provided having a linearly elongated main body terminated at each end by plug forming an anchor plug. A replaceable wing assembly is affixed to each anchor plug. A sound generation mechanism is further incorporated in one said anchor plug. As the toy is flying through the air, the wings provides a visual ‘flapping’ like stimuli, similar to that of the wings of a bird. An audible stimuli is added during the tossing or retrieval of the toy. The instant abstract is neither intended to define the invention disclosed in this specification nor intended to limit the scope of the invention in any way.

### RELATED APPLICATIONS

The present application is a Continuation in Part of U.S. Ser. No. 13/756,171, filed on Jan. 31, 2013 and incorporated by reference as if fully rewritten herein.

### BACKGROUND OF THE INVENTION

1. Field of the Invention

The present invention is directed generally to pet toys, and particularly to a pet toy designed to appeal to an animal's instinctive behaviors and facilitate activities based on such instincts.

2. Description of the Related Art

Dogs enjoy retrieving various types of objects such as sticks, balls, flying discs, and the like. Many breeds have an enhanced enjoyment in “playing fetch” in that such activities have been bred into such lines. Retrievers, bird dogs or gun dogs have been bred to retrieve game foul, spaniels to flush birds from the brush, and other such similar activities. Typically, such breads can be entertained by retrieving a flying disc is made from a plastic material. The disc has an outer side with a generally smooth surface and an underside that has a rim extending along the periphery of the disc. The rim is raised from the rest of the disc so that the dog may easily grip the rim between its jaws.

A problem may occur, however, when the dog seeks to retrieve the disc in that the disc may not always be easily gripped by the dog. That is, if the disc lands with the underside facing upwardly, the rim is exposed which the dog may grip with its teeth. If the disc lands with the underside facing downwardly, the dog may have some difficulty in grasping the smooth side of the disc with its teeth.

Therefore, the dog may not be able to retrieve the disc, thereby decreasing the enjoyment of the game by both the person throwing the disc as well as the dog.

Another problem may occur in that even though such breeds have the instinct to retrieve, a plastic disc shaped object just simply will not stimulate this instinct. It has been found that interactive toys are more successfully interactive if they have been designed with a fundamental understanding of the animal's biological behavior, instincts, unique senses and physical capabilities and needs. In order to accomplish this, the interactive toy must stimulate and reward positive mental and physical activity through real sounds, sights, tactile feel, aroma, movement, and the like.

Therefore, a need exists for a durable dog fetch and retrieve toy that is capable of providing the stimulus that triggers the animal's instinctive retrieving behaviors.

### SUMMARY OF THE INVENTION

It is an object of the present invention to provide a fetch and retrieve pet toy designed to appeal to an animal's instinctive behaviors and facilitate activities based on such instincts.

It is a feature of the present invention to provide an elongated fetch toy having flappable appendages connected to either side.

Briefly described according to the preferred embodiment of the present invention, a fetch and retrieve pet toy is provided having a linearly elongated cylindrical body formed of rotational molded plastic, or alternately formed of closed cell foam. The cylinder has an outer body surface that may form a texture, both to aid in gripping or as stimulation of a pet mouth and gums when chewed. The generally cylindrical body is elongated about a linear centerline, and may further form an internal conduit, chamber or cavity. Such a hollow construction may provide overall buoyancy, as well as provide a resilience to the body or reduce the overall amount of material required as compared to a solid body; however, such advantages may be also achieved without a hollow construction through design selection of configuration, shape and material selection and, as such, the formation of a hollow body should not be seen as limiting to the present invention. At either opposed end are connected a replaceable appendage having in a plurality of individual fingered flexible cloth protuberances. Each of these ‘flappable’ appendages are connected to either opposed end of the body by any number of attachment or integration methods or mechanism. In one preferred embodiment, a threaded or serrated plug is received within a cavity orifice at each end to provide an attachment anchor for the appendages. Such a construction allows for easy of installation, through a snapping or threading of the plug, which provides an easy of construction that further allows for variability of design aesthetic, but also allows for replacement of the ‘flappable’ appendages should they become worn or damages. Finally, the incorporation of a sound mechanism, such as through the use of a reed type “squeaker” or electronically generated, motion activate sound module. Such a sound mechanism may be incorporated within an internal cavity or within the construction of an end plug.

According to the preferred embodiment, the present invention provides a pet toy capable of easily being tossed by the owner, easily caught or captured by the pet, and provides a visual stimuli similar to that of an injured or downed winged prey. Additionally, the incorporation of a sound mechanism can provide a simultaneous audible stimuli, either as tossed, as grasped or both. Such stimulation triggers the naturally bred fetching instincts of some dog breeds.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which;

FIG. 1. is a front plan view of fetch and retrieve tossing toy according to the preferred embodiment of the present invention;

FIG. 2. is a cross sectional view taken along the linear centerline thereof;

FIG. 3 is an exploded perspective and partially cross sectioned view of a push plug 20 for use in conjunction with a fetch and retrieve tossing toy according to the present invention and according to a first alternate embodiment;

FIG. 4 is an exploded perspective and partially cross sectioned view of a push plug 22 for use in conjunction with a fetch and retrieve tossing toy according to the present invention and according to a second alternate embodiment;

FIG. 5 is an exploded perspective and partially cross sectioned view of a push plug 24 for use in conjunction with a fetch and retrieve tossing toy according to the present invention and according to a third alternate embodiment; and

FIG. 6 is a pictorial view of fetch and retrieve tossing toy according to the preferred embodiment of the present invention shown in use.

### DESCRIPTION OF THE PREFERRED EMBODIMENTS

The best mode for carrying out the invention is presented in terms of its preferred embodiment, herein depicted within the Figures.

### 1. Detailed Description of the Figures

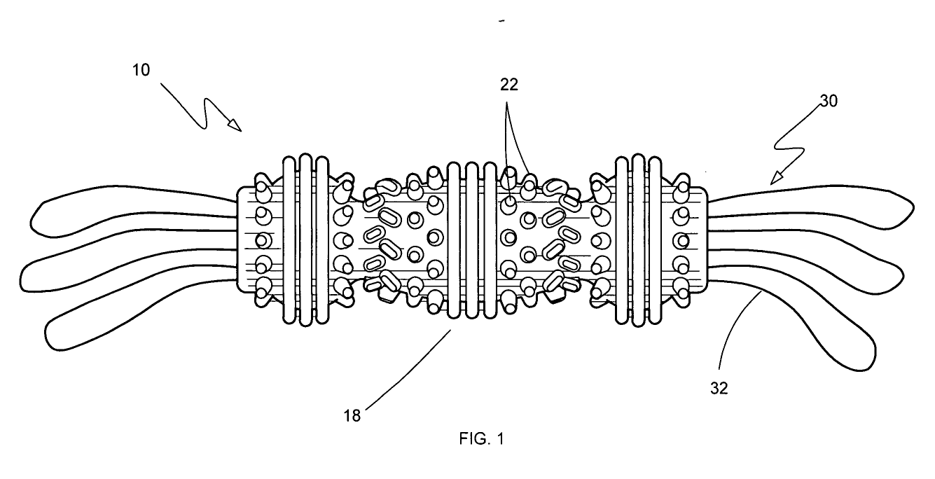

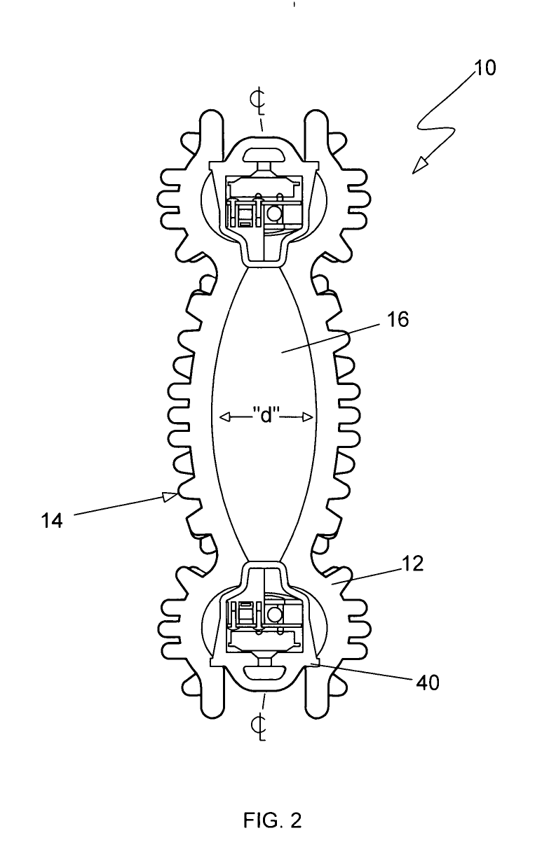

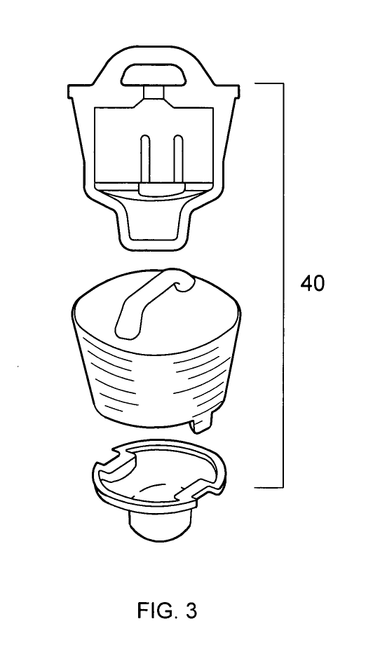

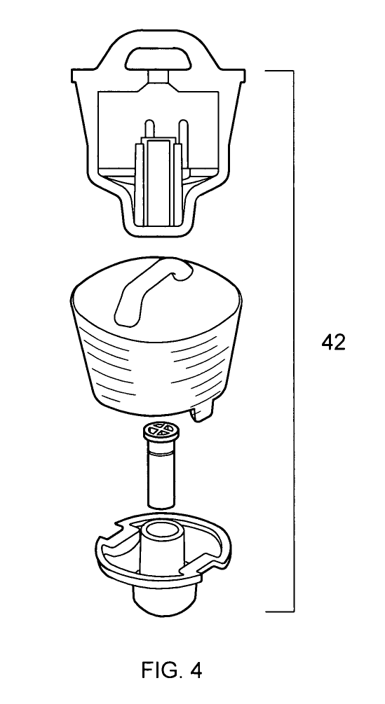

Referring now to FIG. 1-5, a fetch and retrieve pet toy, generally noted as 10, is provided according to a preferred embodiment of the present invention. The toy 10 is provided having a linearly elongated body 12 formed of rotational molded plastic, or alternately formed of closed cell foam. Such as construction forms a durable outer biting surface 14, while at the same time being capable of flotation if placed in water. The body 12 forms an elongated member that can include a generally cylindrical shape and having an outer diameter “d” sufficiently small to allow for grasping and carrying in a dog's mouth. In a commercial embodiment, small, medium and large diameters of 1.34 inches, 2.07 inches, and 2.56 inches, respectively, are provided. However, such dimensions are merely exemplary and are in no way intended to be limiting. Similarly, the body 12 of a commercial embodiment have varying lengths of small, medium and large being of approximately 5.5 inches, 6.5 inches, and 7.75 inches, respectively.

The use of rotational molded plastic for the body 12 forms a hollow double wall that can provide flexibility. Being hollow, sufficient buoyancy is achieved to act as a flotation device in water. Alternately, the body 12 could be formed of closed cell foam to provide similar performance and cost, but without the capacity to incorporate a squeaker. The body 12 has an outer cylindrical surface 18, and forms an internal cavity 20 along the elongated centerline. The outer surface 18 may form a texture 22, both to aid in gripping or as stimulation of a pet mouth and gums when chewed. The generally cylindrical body 12 is elongated about a linear centerline “”, and may further form an internal conduit, chamber or cavity. Such a hollow construction may provide overall buoyancy, as well as provide a resilience to the body or reduce the overall amount of material required as compared to a solid body; however, such advantages may be also achieved without a hollow construction through design selection of configuration, shape and material selection and, as such, the formation of a hollow body should not be seen as limiting to the present invention.

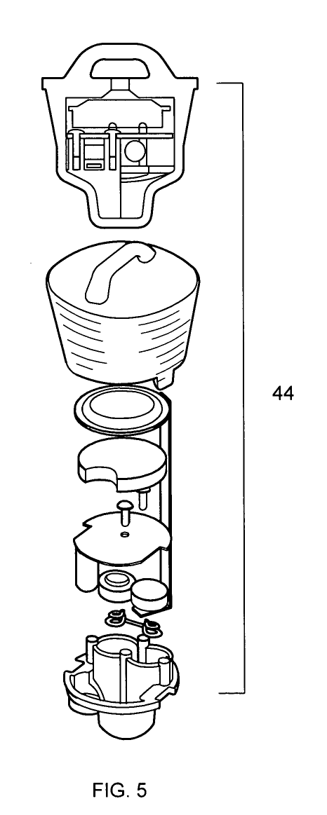

At either opposed end are connected a replaceable wing-like appendage 30 having in a plurality of individual fingered flexible cloth protuberances 32. As shown best in conjunction with FIG. 4, each of these ‘flappable’ appendages 30 are connected to either opposed end of the body 12 by any number of attachment or integration methods or mechanism. In one preferred embodiment, a threaded or serrated plug 40 is received within a cavity orifice 16 at each end of the cavity 20 to provide an attachment anchor for the appendages 30. Such a construction allows for easy of installation, through a snapping or threading of the plug 40, which provides an easy of construction that further allows for variability of design aesthetic, but also allows for replacement of the ‘flappable’ appendages 40 should they become worn or damages.

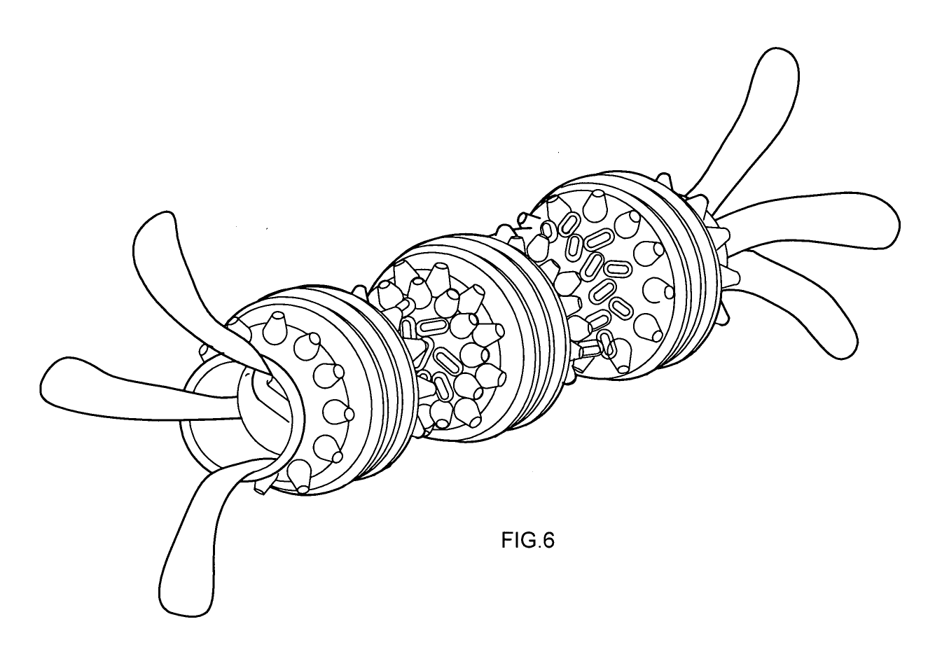

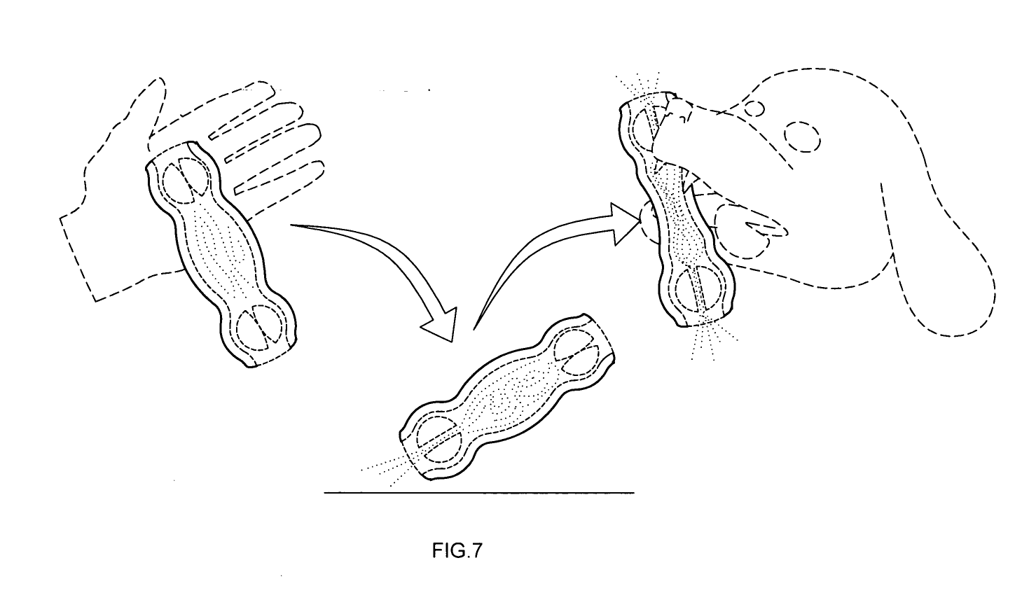

As shown in conjunction with FIG. 5-6, the incorporation of a sound mechanism may be further provided. A sound mechanism may be through the use of a reed type “squeaker”, as shown in FIG. 5, or electronically generated, motion activate sound module as shown in FIG. 6. Such a sound mechanism may be incorporated within an internal cavity or within the construction of an end plug. In any configuration, the plug ends are connected a replaceable wing appendages 30. Each wing 30 of the commercial embodiment is anticipated has having varying lengths of small, medium and large being of 3.5 inches, 6 inches, and 8 inches, respectively. Each wing 30 may be constructed using two halves of different colors on each side, respectively, further emulating the color contrast typically found naturally on the wings of many birds. Each wing 30 may further have a plurality of individual fingered flexible cloth protuberances 32. Each of these wings 30 are freely flexible and moveable, creating a ‘flapping’ motion when thrown.

### 2. Operation of the Preferred Embodiment

As shown in conjunction with FIG. 7, in operation the present invention is utilized like a convention fetch and retrieve toy, being tossed for purpose of being chased, caught and returned by the user's pet. The elongated, tubular nature of the body 12 provides a pet toy capable of easily being tossed by the owner and easily caught or captured by the pet. As the toy 10 is flying through the air, he wings 30 provides a visual ‘flapping’ like stimuli, similar to that of the wings of a bird. The bicolor construction further reinforces this stimulation which triggers the naturally bred fetching instincts of some dog breeds. Should the wings 30 become worn or damaged, the user can remove the wing 30 at the plug 40 and replaced with a suitable replacement component of similar or like construction.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A fetch and retrieve pet toy comprising:
a linearly elongated body having a first end opposite a second end;
a first removable plug affixed to said first end;
a second removable plug affixed to said second end;
a first flexible wing affixed to said first removable plug; and
a second flexible wing affixed to said second removable plug;
wherein each wing has a plurality of individual fingered flexible cloth protuberances that are freely flexible and moveable, creating a ‘flapping’ motion when thrown.

2. The pet toy of claim 1, further comprising a noise making device incorporated into said first plug.

3. The pet toy of claim 2, wherein said noise making device is a reed type squeaker.

4. The pet toy of claim 2, wherein said noise making device is an electronically generated, motion activate sound module.

5. A pet toy comprising:
a linearly elongated body forming a durable outer biting surface and having an outer diameter sufficiently small to allow for grasping and carrying in a dog's mouth;
said body having a first end opposite a second end;
a first wing-like appendage having a plurality of individual fingered flexible protuberances affixed to said first end via a first connection mechanism.

6. The pet toy of claim 5, further comprising:
a second wing-like appendage having a plurality of individual fingered flexible protuberances affixed to said second end via a second connection mechanism.

7. The pet toy of claim 6, wherein said first connection mechanism comprises a first threaded or serrated plug received within a first cavity orifice formed at said first end, said first plug further provide an attachment anchor for the first appendage.

8. The pet toy of claim 7, wherein said second connection mechanism comprises a second threaded or serrated plug received within a second cavity orifice formed at said second end, said second plug further provide an attachment anchor for the second appendage.

9. The pet toy of claim 8, further forming an internal conduit, chamber or cavity formed within said body.

10. The pet toy of claim 9, wherein said body is formed of rotational molded plastic.

11. The pet toy of claim 5, wherein said body is formed of closed cell foam.

12. The pet toy of claim 9, wherein:
said body has an outer cylindrical surface forming said internal conduit, chamber or cavity along an elongated centerline; and
said outer surface form a texture to aid in gripping or as stimulation of a pet mouth and gums when chewed.

13. The pet toy of claim 7, further comprising a sound mechanism incorporated in said first plug.

14. The pet toy of claim 8, further comprising a sound mechanism incorporated in said first plug.

15. The pet to of claim 7, wherein said sound mechanism comprises a reed type squeaker

16. The pet toy of claim 7, wherein said sound mechanism comprises an electronically generated, motion activate sound module.

17. The pet to of claim 8, wherein said sound mechanism comprises a reed type squeaker.

18. The pet toy of claim 8, wherein said sound mechanism comprises an electronically generated, motion activate sound module.

19. A method of playing fetch with a pet comprising the steps:
a. Providing a linearly elongated toy having at least one plug anchor at one end and having a least one wing attached to at least one plug anchor;
b. Tossing said toy such that each said wing provides a visual ‘flapping’ like stimuli, similar to that of the wings of a bird.

20. The method of claim 19, wherein said linearly elongated toy further has a sound generating.
